(19) United States
(12) Patent Application Publication
(10) Pub. No.: US 2010/0196642 A1
(43) Pub. Date: Aug. 5, 2010

(54) SENSOR HOUSING

(76) Inventors: Christian LANGER, Berlin (DE); Sebastian Taeubert, Berlin (DE); Joerg Geipel, Berlin (DE)

Correspondence Address: Muncy, Geissler, Olds & Lowe, PLLC, 4000 Legato Road, Suite 310, FAIRFAX, VA, 22033, US

(21) Appl. No.: 12/694,884

(22) Filed: Jan. 27, 2010

Related U.S. Application Data
(60) Provisional application No. 61/226,206, filed on Jul. 16, 2009.

(30) Foreign Application Priority Data
Feb. 2, 2009 (EP) 09001387.1

(51) Int. Cl. B29C 65/58; H02B 1/26

(52) U.S. Cl. 428/36.8; 156/304.2; 361/600

(57) ABSTRACT

A method is provided for inserting a plastic body into an opening of a sensor housing, whereby the opening has a lateral surface with an edge, in that a collar-shaped bead is formed at the edge and a shoulder-shaped ledge at the lateral surface for the placement of the plastic body, before the placement of the plastic body a strip-like seal is introduced onto the ledge, the plastic body is placed on the ledge of the lateral surface in such a way that a lateral surface of the plastic body is lined up with the lateral surface of the sensor housing in a butt-joint-like manner, a form-fitting, elastically supported connection is created by means of forming between at least one part of the lateral surface of the sensor housing and one part of the lateral surface of the plastic body, so that a substantially seamless and substantially smooth transition between the sensor housing and the plastic body is formed at the connection site on the top side of the sensor housing and of the plastic body.

This nonprovisional application claims priority to European Patent Application No. 09001387.1, which was filed on Feb. 2, 2009, and to U.S. Provisional Application No. 61/226,206, which was filed on Jul. 16, 2009, and which are both herein incorporated by reference.

### BACKGROUND OF THE INVENTION

1. Field of the Invention

The invention relates to a method for inserting a plastic body and to a sensor housing.

2. Description of the Background Art

The insertion of plastics into a metal housing is an important element in technology, particularly in fields in which optical control of fabrication processes is necessary. In the field of food technology, connections of this type often have increased requirements in regard to physical and chemical properties; in particular, a bond of this type must meet high requirements with respect to reliability and tightness and comply with the corresponding standards. Further, connections of this type are subject to highly varying temperatures in the range of from −40° C. to 120° C. and pressure variations in the range of several bars. To be able to meet these high requirements, in conventional methods the connection sites between the housing and the plastic body are protected by means of mechanical fastening means, such as screws and clamps, and/or chemical sealants generally in the form of adhesives. It is disadvantageous, however, that the adhesives and/or sealing means introduced between the sealing surfaces of the adjacent lateral surfaces of the housing edge and the plastic body contain undesirable ingredients, which may be released and are not sufficiently resistant to aging. In other respects, the manufacturing of mechanical fastening means is costly and they bring about numerous hygienic disadvantages, particularly during cleaning.

It is desirable, furthermore, particularly on the surface at the interface between the two materials to form a transition as flush and seamless as possible to prevent deposition of substances. In general, for this purpose, after the joining laborious mechanical finishing steps are necessary to assure the necessary surface quality.

### SUMMARY OF THE INVENTION

It is therefore an object of the invention to provide a method for inserting a plastic body and a sensor housing, each of which reduce the disadvantages of the prior art.

According to an embodiment of the invention, a method is provided for inserting a plastic body into an opening of a sensor housing, whereby the opening has a lateral surface with an edge, in that a collar-shaped bead is formed at the edge and a shoulder-shaped ledge at the lateral surface for the placement of the plastic body, before the placement of the plastic body a strip-like seal is introduced onto the ledge, the plastic body is placed on the ledge of the lateral surface in such a way that a lateral surface of the plastic body is lined up with the lateral surface of the sensor housing in a butt-joint-like manner, a form-fitting, elastically supported connection is created by means of forming between at least one part of the lateral surface of the sensor housing and one part of the lateral surface of the plastic body, so that a substantially seamless and substantially smooth transition between the sensor housing and the plastic body is created at the connection site on the top side of the sensor housing and of the plastic body.

According a further embodiment of the invention, a sensor housing is provided, which has an opening with an edge and a lateral surface which, perpendicular to the top surface of the sensor housing, forms a reverse profile and a shoulder-shaped ledge, a strip-like seal, lying on the ledge, and a plastic body with a lateral surface, which abuts the lateral surface of the sensor housing partially in a butt-joint-like manner, whereby the bottom side of the plastic body lies partially on the seal, and a connection site, which forms a substantially seamless and substantially smooth transition between the sensor housing and the plastic body on the top side of the sensor housing and of the plastic body.

An advantage of the method of the invention is that two different materials can be joined together without additional mechanical or chemical fastening means. Further, formation of joints and steps at least at their top surfaces is prevented. As a result, it is possible to form an adhesive-free bond, which is impermeable to atmospheric gases and/or liquids as far as possible. In particular, during use in the food sector, the largely seamless nature of the surface and the absence of adhesives prevent undesirable deposition of substances or release of adhesives, which would change for the worse the hygienic or aseptic properties of the bond. Further, due to the forming process in conjunction with matched profile guidance of both lateral surfaces, a smooth transition is achieved between the top side of the sensor housing and the top side of the plastic body without the hitherto necessary additional finishing steps, such as, for example, polishing or milling.

In an embodiment, a reverse profile is formed by the forming at the lateral surface of the sensor housing to secure the plastic body against the sensor housing from perpendicular displacement. Further, it is advantageous that the seal between the sensor housing and the plastic body consists of an elastic material such as, for example, Viton, rubber, or composite plastics, to create an elastic form fit, which acts substantially perpendicular to the metal surface. It is advantageous hereby if the outer edge of the plastic body is suitably chamfered to promote the formation of the undercut lateral surface of the sensor housing. According to another refinement, it is advantageous to provide the lateral surface of the plastic body with a stepped ledge as well. In this regard, the profile of the ledge is suitably selected, so that during forming only the bottom side of the ledge of the plastic body lies on the seal and at least one part of the bottom side of the plastic body can act as a spring between the edges of the sensor housing during the forming process.

A possibility for the control of manufacturing processes can be created by this design, particularly with use of optically transparent plastics, without damage to the sensors due to direct contact with chemically or mechanically aggressive materials. Furthermore, selecting of suitable plastics makes it possible to send electrical or magnetic fields through the plastic body, which is generally made discoid, or to receive these fields. Fields of this type are generally screened by metals.

Tests by the applicant have shown that in the housing of the invention with an inserted plastic body the seal is preferably made as an elastic, circumferential strip. Furthermore, the elastic properties and the geometric design of the seal can be suitably selected depending on the requirements and on the forces acting during the forming.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a schematic sectional drawing through a sensor housing with a plastic body lying thereupon in the unjoined state;

FIG. 2 shows a schematic sectional drawing in the connected state according to a first embodiment;

FIG. 3 shows a schematic sectional drawing in the connected state according to another embodiment; and

FIG. 4 shows a top view of a sensor housing with an embedded plastic body in the joined state.

### DETAILED DESCRIPTION

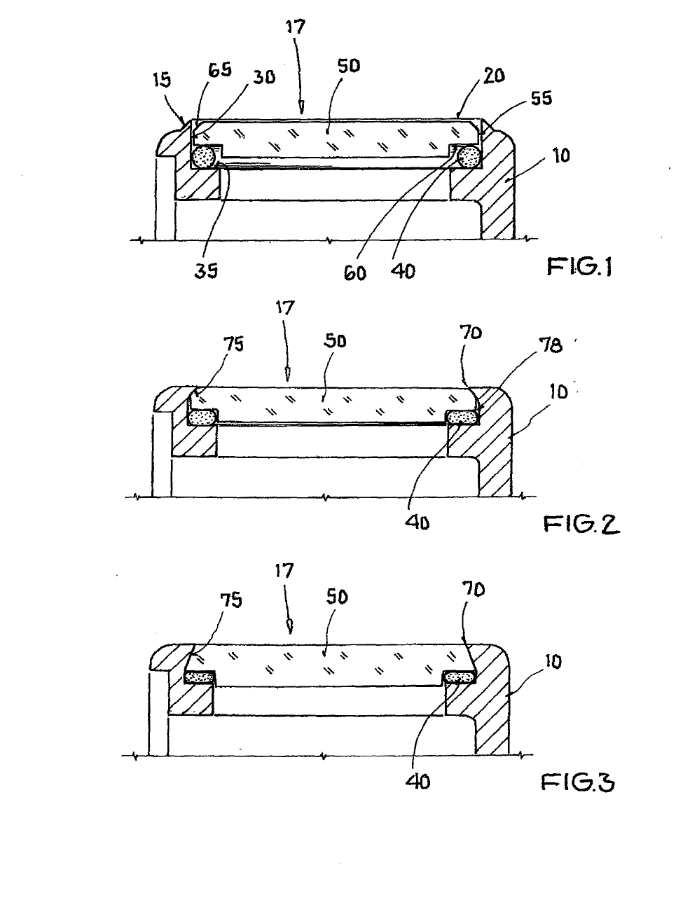

The sectional drawing of FIG. 1 shows an unconnected arrangement of a sensor housing 10 with a bead 15 formed at an edge 20 of sensor housing 10. Further, sensor housing 10 has a lateral surface 30 with a stepped ledge 35. A seal 40 lies upon ledge 35. Further, sensor housing 10 has an opening 17 with an inner plastic body 50. Plastic body 50 has a lateral surface 55 with a stepped ledge 60. Further, a chamfer 65 is formed at the upper edge of plastic body 50. According to the depicted embodiment, the extension of ledge 60 parallel to the top surface of plastic body 50 is selected as somewhat greater than the extension of ledge 35 of sensor housing 10, which is made particularly of metal. This is preferable, because then the plastic body can act somewhat as a spring when being pressed in or during the forming process. Further, the extension of ledge 35 in a direction perpendicular to the top surface corresponds to the thickness of ledge 55 of plastic body 50 and the thickness of seal 40. According to the depicted embodiment, the lateral surfaces 55 of plastic body 50 and of sensor housing 10 are arranged in a butt-joint-like manner.

An embodiment according to the invention of sensor housing 10 and of plastic body 50 in a connected state, i.e., after use of the forming process, is shown in FIG. 2. In this regard, lateral surface 30 of sensor housing 10 is connected largely form-fittingly with lateral surface 55 of plastic body 50. Bead 15, as shown in FIG. 1, is no longer present on the top surface of sensor housing 10, because the corresponding metal of sensor housing 10 with the formation of a reverse section 75 of side edge 30 of sensor housing 10 forms a form fit with chamfer 65, which can be formed by pressing or another method known to one skilled in the art. Furthermore, the top surface of plastic body 50 forms a smooth and seamless transition with the top surface of sensor housing 10 at connection site 70. Seal 40 is elastically deformed by the forming and now presses plastic body 50 in a direction perpendicular to the surface onto the reverse section 75 of lateral surface 35 of sensor housing 10. Further, by means of seal 40, lateral surface 35 is sealed against lateral surface 55 with the formation of a gap 78. Depending on the size and elasticity of the circumferential seal 40 and depending on the geometric dimensions of the material properties of the employed metal surfaces and plastic surfaces, as well as the geometry of the stepped ledges at the lateral edges, both the contact pressure of the plastic body against the sensor housing and the size of the gap at the lateral surface can be adjusted. Tests by the applicant have shown that despite a vertical gap between the seal and the lateral edge of the sensor housing, reliable sealing in the area of the transition between the plastic body and the sensor housing is assured.

According to the embodiment of FIG. 3, the sectional view in the area of lateral surfaces 30 of sensor housing 10 and lateral surfaces 55 of plastic body 50 shows a complete form fit between the two surfaces. Accordingly, the space between ledge 35 and ledge 60 is completely filled by the seal.

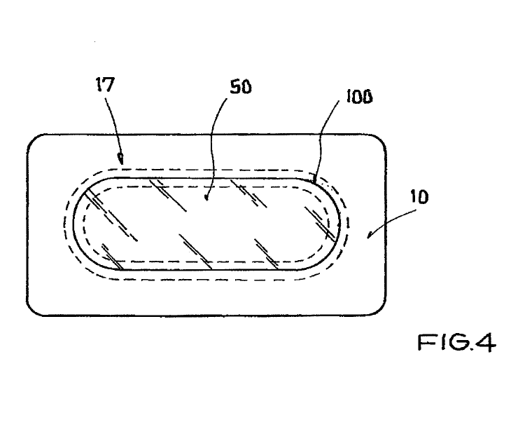

FIG. 4 shows a top view of a sensor housing 10 produced by the method of the invention and having an inserted plastic body 50. At a connection site 100, sensor housing 10 and plastic body 50 form a virtually seamless and virtually smooth transition. Despite the small curvature radius along connection site 100, the appropriate ductility of the metal used for sensor housing 10 assures that a transition that is largely seamless and as smooth as possible is formed by means of the forming also in the edge regions on the top surface, without a mechanical finishing treatment of the top surface being necessary. Further, a reliable, mechanically strong, tight connection without the use of mechanical or chemical fastening means is provided, which is especially suitable for use in the field of food technology.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A method for inserting a plastic body into an opening of a sensor housing, the opening having a lateral surface with an edge, the method comprising:
forming a collar-shaped bead at the edge and a shoulder-shaped ledge at the lateral surface for the placement of the plastic body;
introducing, before the placement of the plastic body, a strip-like seal onto the ledge;
placing the plastic body on the ledge of the lateral surface of the sensor housing such that a lateral surface of the plastic body is lined up with the lateral surface of the sensor housing in a butt-joint-like manner; and
forming a form-fitting elastically supported connection by forming between at least one part of the lateral surface of the sensor housing and one part of the lateral surface of the plastic body so that a substantially seamless and substantially smooth transition between the sensor housing and the plastic body is formed at the connection site on the top side of the sensor housing and of the plastic body.

2. The method according to claim 1, wherein a reverse profile is formed by the forming at the lateral surface of the sensor housing.

3. The method according to claim 1, wherein a stepped ledge is formed at the lateral surface of the plastic body.

4. The method according to claim 1, wherein an elastic form fit, which presses the plastic body substantially perpendicular in the direction of the surface of the housing surface, is created by the seal between the sensor housing and the plastic body.

5. The method according to claim 1, wherein an adhesive-free bond, which is impermeable to liquids, is formed between the sensor housing and the plastic body.

6. The method according to claim 1, wherein an adhesive-free bond, which is impermeable to atmospheric gases, is formed between the sensor housing and the plastic body.

7. A sensor housing comprising:
an opening with an edge and a lateral surface of a sensor housing, which, perpendicular to the top surface of the sensor housing, has a reverse profile and a shoulder-shaped ledge;
a strip-like seal lying on the ledge of a plastic body with a lateral surface, which abuts the lateral surface of the sensor housing partially in a butt-joint-like manner, and the bottom side of the plastic body lies partially on the seal; and
a connection site, which forms a substantially seamless and substantially smooth transition between the sensor housing and the plastic body on the top side of the sensor housing and of the plastic body.

8. The sensor housing according to claim 7, wherein the sensor housing has an opening with the plastic body arranged therein.

9. The sensor housing according to claim 7, wherein the seal is formed as an elastic, circumferential strip.

10. The sensor housing according to claim 7, wherein the connection site forms an adhesive-free transition between the lateral surface of the sensor housing and the lateral surface of the plastic body.
